(19) United States
(12) Patent Application Publication
(10) Pub. No.: US 2010/0245998 A1
(43) Pub. Date: Sep. 30, 2010

(54) Stereoscopic Image Formation Techniques

(75) Inventors: Vivian K. Walworth, Concord, MA (US); W. Dennis Slafer, Arlington, MA (US)

Correspondence Address: McDermott Will & Emery, 600 13th Street, NW, Washington, DC, 20005-3096, US

(73) Assignee: MICROCONTINUUM, INC., Cambridge, MA (US)

(21) Appl. No.: 12/749,241

(22) Filed: Mar. 29, 2010

Related U.S. Application Data
(60) Provisional application No. 61/164,004, filed on Mar. 27, 2009.

(51) Int. Cl. G02B 27/26; B05D 5/06

(52) U.S. Cl. 359/465; 427/163.1

(57) ABSTRACT

An aspect of the present disclosure provides for a quarter-wave retarder film that is overlaid onto a linearly-polarized stereoscopic image pair in an appropriate orientation in order to produce an image that is viewable using circularly polarized viewing glasses for increased viewing comfort and head-tilt resistance. Another aspect of the present disclosure enables the production of StereoJet-type ink jet images through the use of two separate single-sided clear polarizer substrates with the stretch orientation parallel to the running edge of the support layer. A further aspect of the present disclosure is directed to the production of laminated stereoscopic images in which the spacing of the image planes of the members of the image pair can be made in close proximity, farther proximity, or at an intermediate proximity to achieve desired optical, mechanical and/or visual results.

### RELATED APPLICATION

This application claims priority to U.S. Provisional Patent Application No. 61/164,004, filed Mar. 27, 2009 and entitled “Circular Polarization Techniques for Creating and Viewing Stereoscopic Images,” the entire contents of which are incorporated herein by reference.

### BACKGROUND

Various techniques have been utilized previously for printing stereoscopic images. Louis Arthur Ducos du Hauron described the anaglyph process, which utilized color encoding of left- and right-eye images, in U.S. Pat. No. 44,666 (1895), and that process continues to be widely used for printing red/blue stereoscopic images, although it lacks the ability to represent full-color images accurately. Land and Mahler described the first Vectograph process, in which black-and-white images were encoded by polarization, in U.S. Pat. No. 2,203,687 (1940), and Land described a variety of applications of Vectograph imaging. See, Land, J. Opt. Soc. Amer., 30, 230-238 (1940). This technology is still widely used in ophthalmological testing and training

The Vectograph sheet included a two-sided material, with oppositely oriented polyvinyl alcohol layers on the respective surfaces of a transparent cellulose acetate or cellulose acetate-butyrate support. The orientation of the respective polyvinyl alcohol layers was +45/−45 degrees. The process utilized an iodine “ink” to stain paired left- and right-eye relief images in gelatin. The two relief images were registered stereoscopically, then hinged together with tape and inked. A “sandwich” including a sheet of Vectograph film inside the hinged images was then passed through a pair of rollers to effect the transfer of the ink images from the gelatin layers into the polyvinyl alcohol layers of the Vectograph sheet. After treatment in a bath of dilute boric acid, the resulting composite image, viewed through complementary −45/+45 linear polarizing glasses, provided an effective stereoscopic representation of the original three-dimensional scene or subject.

In further applications, scientists at Polaroid Corp. developed several processes for creating stereoscopic images in full color. For example, cyan, magenta, and yellow dichroic dyes—i.e., dyes capable of aligning with an oriented polyvinyl alcohol substrate—were used to stain sets of relief images formed in Kodak Dye Transfer Film, and these dyed matrices were used in successive transfer operations to create full-color Vectograph images. The images were viewed through complementary −45/+45 linear polarizing glasses (lantern slide presentation by E. H. Land at 3th Annual Meeting of the Optical Society of America, Rochester, N.Y., 1953). Although these stereoscopic color images were effective, the process was costly and cumbersome, and Polaroid Corp. did not develop a commercial version.

The concept of printing stereoscopic dye images on Vectograph sheet by ink jet was demonstrated by Walworth and Chiulli at Polaroid Corp. in the early 1980s. Later work by Jay Scarpetti at the Rowland Institute for Science (Cambridge, Mass.) produced excellent stereoscopic images on Vectograph sheet, and this process is referred to as StereoJet imaging technology. A thin layer of carboxymethylcellulose over each polyvinyl alcohol layer served as a metering layer that quickly absorbed the ink droplets as they impinged the surface and moderated their penetration into the underlying polyvinyl alcohol stratum. The carboxymethylcellulose layers were later removed by washing.

Because the two images were printed sequentially onto the two opposite surfaces of a single sheet in the prior process, a delay period was required between the two printing steps, with the time interval ranging from a few hours to overnight in order for the printing of the second side not to cause smearing of the still-wet first side and to allow time for the ink to imbibe into the PVA layer. It was also necessary to print the second image in accurate register with the first image. If the second image was improperly registered with respect to the first, or if the second image exhibited a printing defect, the stereoscopic print was irreversibly ruined and not usable. If the registration and quality of the dual images was acceptable, after the holding period the completed image was washed to remove residual (CMC), then dried and mounted.

The resulting stereoscopic images were viewed with glasses having complementary linear polarization. Although the full color stereoscopic image displays were demonstrated, it was noted that the observer needed to keep his head very erect, as tilting the head impaired the discrimination between images, so that each eye would inadvertently see a ghost of the image intended for the other eye and thereby degrade the stereoscopic effect.

FIG. 1. depicts a drawing 100 with three views comparing various forms of polarized light, as is known in the prior art. FIG. 1 shows different forms of light polarization, showing the vector sum of the orthogonal components of linear, circular, and elliptical polarized light. Linear polarization is a special case in which the resolved (orthogonal) vectors are in phase, while difference in amplitudes determines the direction of the vector sum. Circular polarization is another special case that results from a ±90 degree phase shift between orthogonal components of equal amplitude (left or right “handedness” is determined by one of the components leading or lagging the other). The most general case is elliptical polarization, in which the phase shift and amplitude have any values other than those for linear or circular polarization.

FIG. 2. depicts a drawing 200 illustrating how a quarter-wave retarder (or, ¼-wave plate) converts linear to circular polarization, as is known in the prior art. FIG. 3 depicts how the introduction of a ¼-wave retarder after the output of a linear polarizer results in a 90-degree phase shift (‘retardation’) of one of the orthogonal vectors, establishing the conditions for circular polarization shown in. FIG. 2.

Prior art Vectograph sheets, including 2 layers of PVA stretched at 45 degrees laminated to either side of an acetate support film, were made in limited supply, only manufactured by a single facility (Polaroid Corp.'s Polarizer Division, later part of 3M Corp.). The material was costly and the supply was limited during the 1990s, with production ultimately being halted when the sole manufacturing line was decommissioned and disassembled. This type of film is no longer commercially available. Thus, prior techniques of stereographic image formation suffer from various deficiencies and disadvantages.

### SUMMARY

Aspects and embodiments of the present disclosure address problems previously described by providing improved techniques, including systems, methods, and means for forming high-quality stereoscopic images by using ink jet printing.

An aspect of the present disclosure provides for a quarter-wave retarder film that is overlaid onto a linearly-polarized stereoscopic image pair in an appropriate orientation in order to produce an image that is viewable using circularly polarized viewing glasses for increased viewing comfort and head-tilt resistance. Such circularly polarized viewing glasses are readily available due to the predominance of the Real D System for digital stereoscopic cinema, which utilizes glasses that are well suited for viewing the images of this invention.

Another aspect of the present disclosure enables the production of StereoJet-type ink jet images through the use of two separate single-sided clear polarizer substrates with the stretch orientation parallel to the running edge of the support (typically cellulose triacetate) layer. This material is commonly used in the manufacture of continuous sheet polarizers, in polarizing glasses, as a component of LCD TV's and displays, etc. The use of linear sheet by this invention offers several advantages over the prior art for making StereoJet-type images: it is readily available commercially, it is produced in a greater range of film widths than the previous (Vectograph) substrate for printing larger stereoscopic images. A particular improvement over the prior art is that the use of separate sheets allows both right- and left-hand images to be printed and inspected for defects separately. If the two image components meet the quality specifications, they can be “dry laminated” to determine proper registration, then permanently laminated.

A further aspect of the present disclosure is directed to the production of laminated stereoscopic images in which the spacing of the image plane of each member of the image pair can be made in close proximity (images face-to-face), farther proximity (images back-to-back), or at an intermediate proximity (face-to-back and vice versa) to achieve desired optical and/or visual effects. It should be noted that the images are preferably printed with the correct orientation (normal or mirror image) so that the proper pair will be formed during assembly.

An exemplary embodiment can include a sheet material structure for displaying a stereoscopic image. The structure can include a first sheet having an image formed from the application of dichroic ink to a linearly polarized substrate; a second sheet having a second image formed from the application of dichroic ink to a second linearly polarized substrate, such that the combined sheets form a right eye and left eye stereoscopic image pair; and a third sheet including a quarter-wave retarder film affixed onto the first and second sheets with an orientation that results in the formation of a circularly polarized image.

The dichroic inks used for the structure can include one or more C, M, Y, and/or K dyes.

A further exemplary embodiment can include a method of forming a stereoscopic print or transparency having a three-dimensional image. The method can include forming a right and left eye image pair on a polarizing film substrate in which a first polarizing image is formed in a first polarizing sheet and a second polarizing image is formed on a second polarizing sheet; causing the first and second sheets to be brought into contact such that the directions of polarization are perpendicular to one another; and placing a third sheet including a quarter-wave retarder over the first and second sheets.

The image can be formed by applying dichroic inks to the substrate using ink jet printing.

The image can be formed by applying dichroic inks to the substrate, using a gravure printing technique.

The image can be formed by applying dichroic inks to the substrate using a flexographic printing technique.

The first and second sheets can be laminated such that the image containing surfaces are facing each other.

The first and second sheets can be laminated such that the image-containing surfaces are facing away from each other.

The first and second sheets can be laminated such that the image-containing surface of one sheet is facing the back side of the other sheet.

The dichroic inks can include any suitable C, M, Y, and/or K dyes.

It will be appreciated that the foregoing embodiments and aspects can be combined or arranged in any practical combinations.

Other features of embodiments of the present disclosure will be apparent from the description, the drawings, and the claims herein.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1. shows a sketch comparing various forms of polarized light, as known in the prior art;

FIG. 2. shows how a quarter-wave retarder converts linear to circular polarization, as known in the prior art;

FIG. 3 shows a cross-sectional view of a structure (not to scale) providing a stereoscopic film image, in accordance with exemplary embodiments of the present disclosure; and

FIG. 4, includes FIGS. 4A-4B, which together depict a box diagram representing a structure, in accordance with exemplary embodiments of the present disclosure.

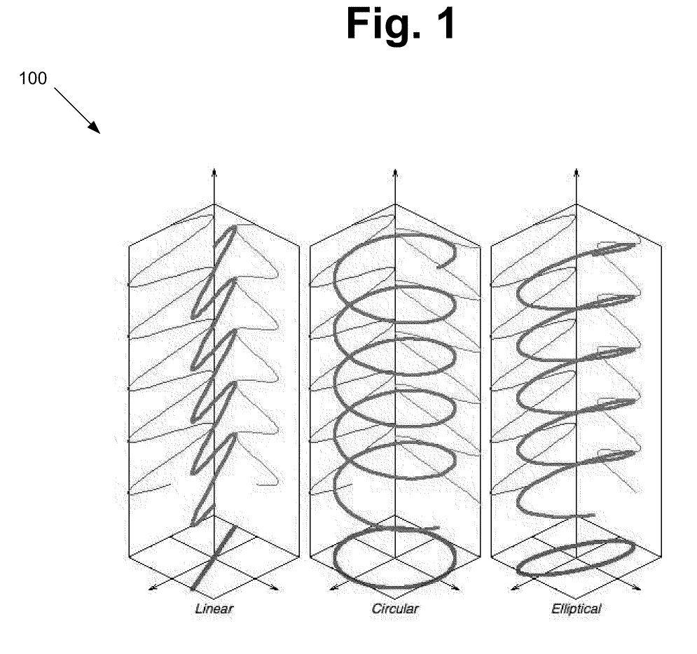

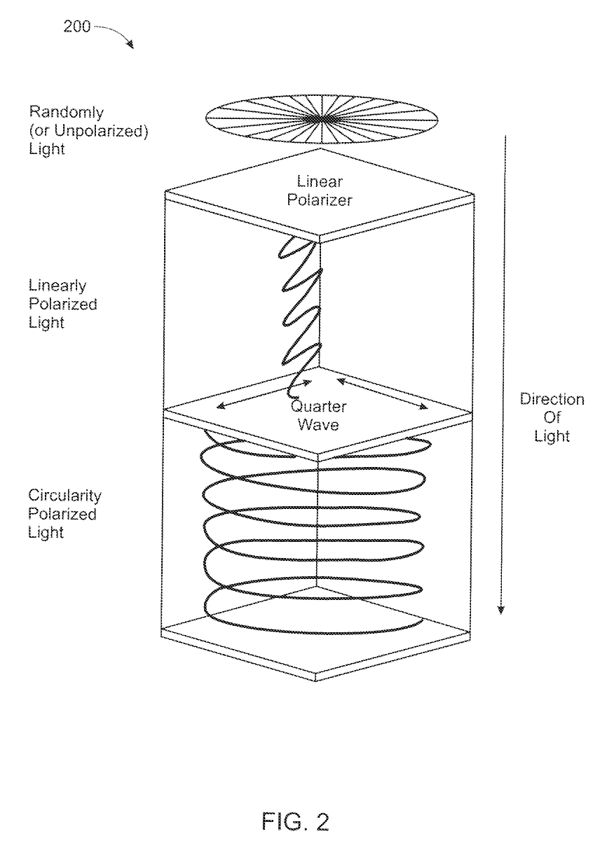

While certain embodiments are depicted in the drawings, one skilled in the art will appreciate that the embodiments depicted are illustrative and that variations of those shown, as well as other embodiments described herein, may be envisioned and practiced within the scope of the present disclosure. Accordingly, the drawings and detailed description are to be regarded as illustrative in nature and not as restrictive.

### DETAILED DESCRIPTION

In the following detailed description, numerous specific details are set forth to provide a full understanding of aspects and embodiments of the present disclosure. It will be apparent, however, to one ordinarily skilled in the art that aspects and embodiments of the present disclosure may be practiced without some of these specific details. In other instances, well-known structures and techniques have not been shown in detail for ease in comprehension.

It is to be understood that both the foregoing summary of the present disclosure and the following detailed description are exemplary and explanatory and are not intended to limit the scope of the present disclosure. Moreover, with regard to terminology used herein, a reference to an element in the singular is not intended to mean “one and only one” unless specifically stated, but rather “one or more.” The term “some” refers to one or more. Underlined and/or italicized headings and subheadings are used for convenience only, do not limit the present disclosure, and are not referred to in connection with the interpretation of the description of the present disclosure.

Aspects and embodiments of the present disclosure address problems previously described by providing improved techniques, including systems, methods, and means for forming high-quality stereoscopic images by using ink jet printing. Benefits include providing images with improved viewing comfort and significantly greater immunity to head-tilt discomfort through the use of common circularly polarized viewing glasses, lower-cost manufacturing from the use of readily available substrates, improved stereoscopic quality by allowing precise registration of the image pair, lower production cost due to the ability to “proof” each image before lamination, and greater manufacturing and optical/visual effects latitude in lamination orientation options (image face to face, back to back, or back to face).

An aspect of the present disclosure provides for a quarter-wave retarder film that is overlaid onto a linearly polarized stereoscopic image pair in an appropriate orientation in order to produce an image that is viewable using circularly polarized viewing glasses for increased viewing comfort and head-tilt resistance. Such circularly polarized viewing glasses are readily available due to the predominance of the Real D System for digital stereoscopic cinema, which utilizes glasses that are well suited for viewing the images of this invention.

Another aspect of the present disclosure enables the production of StereoJet-type ink jet images through the use of two separate single-sided clear polarizer substrates with the stretch orientation parallel to the running edge of the support (typically cellulose triacetate) layer. This material is commonly used in the manufacture of continuous sheet polarizers, in polarizing glasses, as a component of LCD TV's and displays, etc. The use of linear sheet by this invention offers several advantages over the prior art for making StereoJet-type images: it is readily commercially available, it is produced in a greater range of film widths than the previous (Vectograph) substrate for printing larger stereoscopic images. A particular improvement over the prior art is that the use of separate sheets allows both right- and left-hand images to be printed and inspected for defects separately. If the two image components meet the quality specifications, they can be “dry laminated” to determine proper registration, then permanently laminated.

A further aspect of the present disclosure is directed to the production of laminated stereoscopic images in which the spacing of the image plane of each member of the image pair can be made in close proximity (images face-to-face), farther proximity (images back-to-back), or at an intermediate proximity (face-to-back and vice versa) to achieve desired optical and/or visual effects. It should be noted that the images are preferably be printed with the correct orientation (normal or mirror image) so that the proper pair will be superposed during assembly.

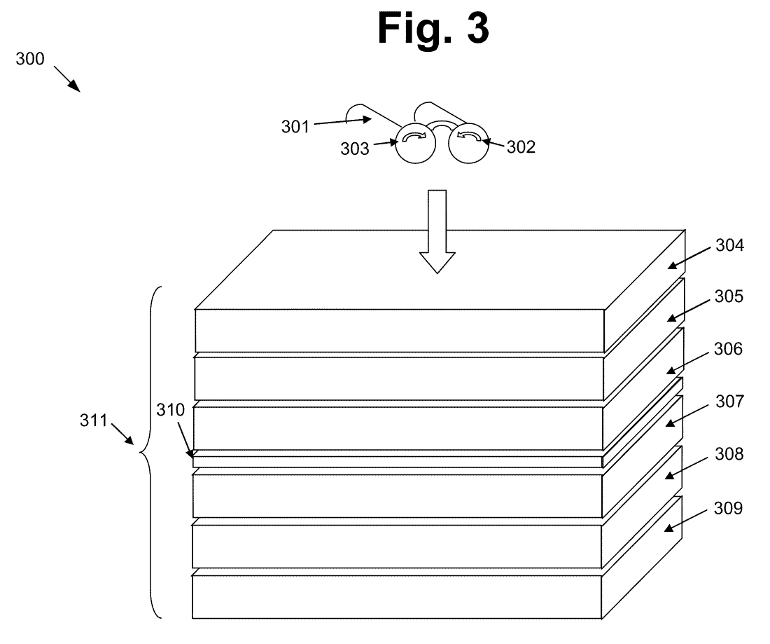

FIG. 3 depicts a structure 300, in accordance with exemplary embodiments of the present disclosure. A stereoscopic image structure 300 can include a stack of laminated sheets including an oriented quarter-wave retarder film (304), a layer, typically including of stretched PVA (305), containing a polarized image and having its direction of linear polarization (direction of stretch) in the direction, a support film (306), typically cellulose triacetate, an adhesive layer (310), another PVA layer (308) having a polarized image and whose axis of polarization is perpendicular to that of the first image (305), a support layer (307) for PVA layer (308), and a layer (309), which can be either a source of illumination (backlight) or a reflective layer, such as silvered paper, etc.

In order to view the image in stereo, circularly polarized glasses 1 are used, wherein each lens 302 & 303 is a circularly polarizer, but of opposite polarization from one another (i.e., L or R handed). Each of the two images in the composite film 311 is transmitted by only one lens and blocked by the other, thus each eye sees only the correct member of the stereoscopic pair of images, producing a stereoscopic image to the glasses wearer.

The image-containing film is typically in the form of a commercially available single film that is made up of the acetate layer and laminated stretched PVA layer (305+306 or 307+308), where the direction of stretch of the PVA is the same as the machine direction of the support (acetate) film. The stack is shown as assembled with the image layers 305 and 308 separated by the two acetate support layers and the adhesive layer, with the image layers in maximum proximity. The stack can also be assembled such that the image layers are closest to one another (i.e., by reversing layers 305 and 306 and 307 and 308). In this case the image layers are in closest proximity. In another case, the image layer of one stack can be assembled so that it is in proximity to the support (PVA) layer of the other, resulting on the intermediate proximity case. Each of these situations can result in different visual and or optical effects and may be used to make use of such effect in certain applications.

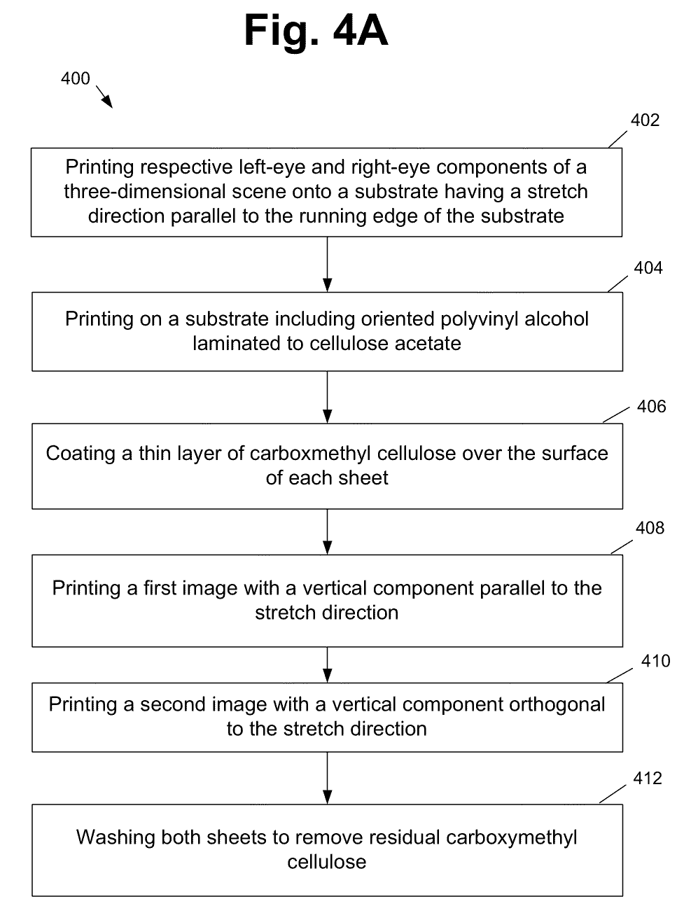

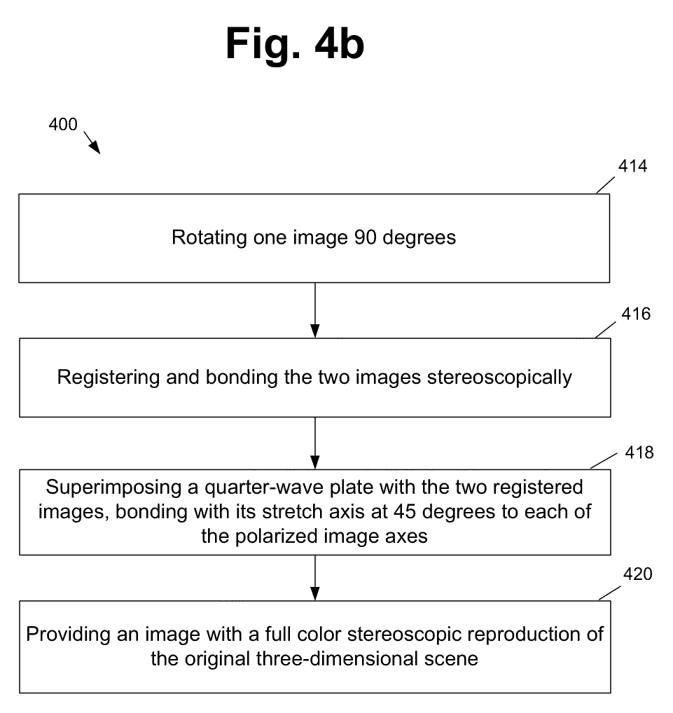

FIG. 4, includes FIGS. 4A-4B, which together depict a box diagram of a method 400, in accordance with an exemplary embodiment of the present disclosure. To demonstrate an exemplary embodiment of a method/structure in accordance with the present disclosure, respective left-eye and right-eye components of a three-dimensional scene were printed onto a substrate including (or consisting of) oriented polyvinyl alcohol laminated to cellulose acetate and having the polyvinyl alcohol stretch direction parallel to the running edge of the substrate (such as that available from US Polarizer LLC, Marlborough, Mass.), e.g., as described at 402 and 404. A thin layer of carboxymethyl cellulose was coated over the surface of each sheet, e.g., as described at 406. One image was printed with its vertical component parallel to the stretch direction, e.g., as described at 408, and the second image was printed with its vertical component at 90 degrees (orthogonal) to the stretch direction, e.g., as described at 410. After printing, both sheets were washed to remove residual carboxymethyl cellulose, e.g., as described at 412. One image was then rotated 90 degrees, e.g., as described at 414, and the two images were registered stereoscopically, e.g., as described at 416. In other words, the two images can be registered with coincident homologous points in the plane of the stereoscopic “window,” and other points displaced according to their respective locations in space—and laminated back-to-back.

With continued reference to FIG. 4, a sheet of quarter-wave retarder (e.g., as made available by Zeon Corporation, Louisville, Colo.) was superimposed with the two registered images, e.g., oriented with its stretch axis at 45 degrees to each of the polarized image axes, e.g., as described at 418. The resulting image provided a full color stereoscopic reproduction of the original three-dimensional scene (object), e.g., as described at 420. The so-produced image, according to this embodiment, when viewed with glasses having complementary circular polarizing lenses, was readily perceived as a three-dimensional scene.

Accordingly, embodiments of the present disclosure can provide benefits relative to previous techniques. For example, embodiments of the present disclosure can provide images with improved viewing comfort and significantly greater immunity to head-tilt discomfort through the use of common circularly polarized viewing glasses, lower-cost manufacturing from the use of readily available substrates, improved stereoscopic quality by allowing precise registration of the image pair, lower production cost due to the ability to “proof” each image before lamination, and greater manufacturing and optical/visual effects latitude in lamination orientation options (image face to face, back to back, or back to face).

While aspects of the present disclosure are described herein in connection with certain embodiments, it should be noted that variations can be made by one with skill in the applicable arts within the spirit of the present disclosure.

One skilled in the art will appreciate that embodiments and/or portions of embodiments of the present disclosure can be implemented in/with computer-readable storage media (e.g., hardware, software, firmware, or any combinations of such), and can be distributed over one or more networks. Steps described herein, including processing functions to derive, learn, or calculate formulas and/or mathematical models utilized and/or produced by the embodiments of the present disclosure, can be processed by one or more suitable processors, e.g., central processing units (“CPUs), implementing suitable code/instructions in any suitable language (machine dependent or machine independent). For example, control signals for printing methods/techniques according to the present disclosure can be transmitted wirelessly (e.g., over IR and/or RF communications networks) and/or sent by electrical signals over a local or wide-area network and/or the Internet or World Wide Web.

Additionally, embodiments of the present disclosure can be embodied in signals and/or carriers, e.g., control signals sent over a communications channel or network. Furthermore, software embodying methods, processes, and/or algorithms of the present disclosure can be implemented in or carried by electrical signals, e.g., for use with the Internet and/or wireless networks.

Various functions and elements described herein may be partitioned differently from those shown without departing from the spirit and scope of the present disclosure. Various modifications to these embodiments will be readily apparent to those skilled in the art, and generic principles defined herein may be applied to other embodiments. Thus, many changes and modifications may be made, by one having ordinary skill in the art, without departing from the spirit and scope of the present disclosure and claimed embodiments.

What is claimed is:

1. A sheet material structure for displaying a stereoscopic image, the structure comprising:
a first sheet having an image formed from the application of dichroic ink to a linearly polarized substrate;
a second sheet having a second image formed from the application of dichroic ink to a second linearly polarized substrate, such that the combined sheets form a right eye and left eye stereoscopic image pair; and
a third sheet including a quarter-wave retarder film affixed onto the first and second sheets with an orientation that results in the formation of a circularly polarized image.

2. The structure of claim 1, wherein the dichroic inks include one or more C, M, Y, and/or K dyes.

3. A method of forming a stereoscopic print or transparency having a three-dimensional image, the method comprising:
forming a right and left eye image pair on a polarizing film substrate in which a first polarizing image is formed in a first polarizing sheet and a second polarizing image is formed on a second polarizing sheet;
causing the first and second sheets to be brought into contact such that the directions of polarization are perpendicular to one another; and
placing a third sheet including a quarter-wave retarder over the first and second sheets.

4. The method of claim 3, wherein the image is formed by applying dichroic inks to the substrate using ink jet printing.

5. Method of claim 3, wherein the image is formed by applying dichroic inks to the substrate, using a gravure printing technique.

6. The method of claim 3, wherein the image is formed by applying dichroic inks to the substrate using a flexographic printing technique.

7. The method of claim 3, wherein the first and second sheets are laminated such that the image containing surfaces are facing each other.

8. The method of claim 3, wherein the first and second sheets are laminated such that the image-containing surfaces are facing away from each other.

9. The method of claim 3, wherein the first and second sheets are laminated such that the image-containing surface of one sheet is facing the back side of the other sheet.

10. The method of claim 3, wherein the dichroic inks include C, M, Y, and/or K dyes.
